(19) United States
(12) Patent Application Publication
(10) Pub. No.: US 2025/0351075 A1
(43) Pub. Date: Nov. 13, 2025

(54) LOW POWER WAKE-UP SIGNAL SUBGROUPING INFORMATION

(71) Applicant: LENOVO (SINGAPORE) PTE. LTD., SINGAPORE (SG)

(72) Inventors: Shwetha Sreejith, Steinbach (DE); Joachim Löhr, Wiesbaden (DE); Prateek Basu Mallick, Dreieich (DE); Karthikeyan Ganesan, Kronberg Im Taunus (DE)

(73) Assignee: LENOVO (SINGAPORE) PTE. LTD., SINGAPORE (SG)

(21) Appl. No.: 18/660,209

(22) Filed: May 9, 2024

(51) Int. Cl. H04W 52/02

(52) U.S. Cl. CPC H04W 52/0229; H04W 52/0219

(57) ABSTRACT

Various aspects of the present disclosure relate to low power wake-up signal subgrouping information. An apparatus, such as a UE, receives low power wake-up signal configuration information comprising low power wake-up signal subgrouping information, and generates, based at least in part on the low power wake-up signal subgrouping information, a low power wake-up signal including a subgroup identifier.

### TECHNICAL FIELD

The present disclosure relates to wireless communications, and more specifically to energy savings in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of”′ or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive low power wake-up signal configuration information including low power wake-up signal subgrouping information; and generate, based at least in part on the low power wake-up signal subgrouping information, a low power wake-up signal including a subgroup identifier.

In some implementations of the method and apparatuses for a UE described herein, the at least one processor is configured to cause the UE to transmit low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping; the payload size includes one or more of a fixed value or a defined parameter including an integer.

In some implementations of the method and apparatuses for a UE described herein, the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the at least one processor is configured to cause the UE to determine, based at least in part on broadcast signaling, one or more of the low power wake-up signal subgrouping information or support for low power wake-up signal subgrouping information.

Some implementations of the method and apparatuses described herein may further include a processor for wireless communication to receive low power wake-up signal configuration information including low power wake-up signal subgrouping information; and generate, based at least in part on the low power wake-up signal subgrouping information, a low power wake-up signal including a subgroup identifier.

In some implementations of the method and apparatuses for a processor described herein, at least one controller is configured to cause the processor to transmit low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping; the payload size includes one or more of a fixed value or a defined parameter including an integer.

In some implementations of the method and apparatuses for a processor described herein, the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the at least one controller is configured to cause the processor to determine, based at least in part on broadcast signaling, one or more of the low power wake-up signal subgrouping information or support for low power wake-up signal subgrouping information.

Some implementations of the method and apparatuses described herein may further include a method performed by a UE, the method including: receiving low power wake-up signal configuration information including low power wake-up signal subgrouping information; and generating, based at least in part on the low power wake-up signal subgrouping information, a low power wake-up signal including a subgroup identifier.

In some implementations of the method and apparatuses described herein, the method further comprising transmitting low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or UE identifier-based subgrouping; the payload size includes one or more of a fixed value or a defined parameter including an integer.

In some implementations of the method and apparatuses described herein, the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; further including determining, based at least in part on broadcast signaling, one or more of the low power wake-up signal subgrouping information or support for low power wake-up signal subgrouping information.

Some implementations of the method and apparatuses described herein may further include a network equipment (NE) for wireless communication to transmit low power wake-up signal configuration information including low power wake-up signal subgrouping information; receive a low power wake-up signal subgroup identifier from a core network for low power wake-up signal subgrouping; and transmit, to a user equipment (UE), a low power wake-up signal including a subgroup identifier.

In some implementations of the method and apparatuses for a NE described herein, the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication; an offset value in a number of frames from a start of a reference frame for a low power wake-up signal occasion to a start of a first paging frame associated with paging frames of the low power wake-up signal occasion; or a subgrouping configuration element for identifying whether to use the network-based subgrouping or the UE identifier-based subgrouping; the low power wake-up signal subgrouping configuration information includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping.

In some implementations of the method and apparatuses for a NE described herein, the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the low power wake-up signal subgrouping information includes one or more of: one or more low power wake-up signal occasions calculated as an offset behind an early paging indication occasion; or one or more low power wake-up signal occasions calculated as an offset behind a paging occasion.

Some implementations of the method and apparatuses described herein may further include a method performed by a NE, the method including: transmitting low power wake-up signal configuration information including low power wake-up signal subgrouping information; receiving a low power wake-up signal subgroup identifier from a core network for low power wake-up signal subgrouping; and transmitting, to a user equipment (UE), a low power wake-up signal including a subgroup identifier.

In some implementations of the method and apparatuses described herein, the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping; the low power wake-up signal subgrouping configuration information includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping.

In some implementations of the method and apparatuses described herein, the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the low power wake-up signal subgrouping information includes one or more of: one or more low power wake-up signal occasions calculated as an offset behind an early paging indication occasion; or one or more low power wake-up signal occasions calculated as an offset behind a paging occasion.

Some implementations of the method and apparatuses described herein may further include a NE for wireless communication to generate low power wake-up signal configuration information including one or more of to: generate, in a round-robin manner, low power wake-up signal subgroup identifiers for user equipment (UEs) within an early paging indication subgroup for network-based subgrouping; or configure a number of low power wake-up signal subgroups as a non-factor of a number of early paging indication subgroups for UE-identifier based subgrouping; and transmit, to the UEs within the early paging indication subgroup, at least some of the low power wake-up signal configuration information.

Some implementations of the method and apparatuses described herein may further include a method performed by a NE, the method including generating low power wake-up signal configuration information including one or more of: generating, in a round-robin manner, low power wake-up signal subgroup identifiers for user equipment (UEs) within an early paging indication subgroup for network-based subgrouping; or configuring a number of low power wake-up signal subgroups as a non-factor of a number of early paging indication subgroups for UE-identifier based subgrouping; and transmitting, to the UEs within the early paging indication subgroup, at least some of the low power wake-up signal configuration information.

### BRIEF DESCRIPTION OF THE DRAWINGS

FIG. 1 illustrates an example of a wireless communications system in accordance with aspects of the present disclosure.

FIG. 2 illustrates an example DownlinkCommonConfigSIB 200.

FIG. 3 illustrates a UERadioPagingInfo IE 300 in accordance with aspects of the present disclosure.

FIG. 4 illustrates an example DownlinkConfigCommonSIB IE 400 in accordance with aspects of the present disclosure.

FIG. 5 illustrates an example DownlinkConfigCommon SIB information element 500 in accordance with aspects of the present disclosure.

FIG. 6 illustrates an example AMF LPPS assistance information IE 600 in accordance with aspects of the present disclosure.

FIG. 7 illustrates an example implementation 700 for LP-WUS subgroup ID based on PEI subgroup in accordance with aspects of the present disclosure.

FIGS. 8 and 9 illustrate example implementations 800, 900 in accordance with aspects of the present disclosure.

FIG. 10 illustrates an example of a UE 1000 in accordance with aspects of the present disclosure.

FIG. 11 illustrates an example of a processor 1100 in accordance with aspects of the present disclosure.

FIG. 12 illustrates an example of a NE 1200 in accordance with aspects of the present disclosure.

FIG. 13 illustrates a flowchart of a method 1300 in accordance with aspects of the present disclosure.

FIG. 14 illustrates a flowchart of a method 1400 in accordance with aspects of the present disclosure.

FIG. 15 illustrates a flowchart of a method 1500 in accordance with aspects of the present disclosure.

### DETAILED DESCRIPTION

In a wireless communications system, a UE and a NE (e.g., a base station) may support wireless communication (e.g., reception and/or transmission of wireless communication) using time-frequency resources. A NE may schedule (e.g., allocate, assign) one or more time-frequency resources via control signaling (e.g., a radio resource control (RRC) message, downlink control information (DCI)) for the wireless communication. The NE may schedule a set of one or more periods (e.g., durations, intervals) for the wireless communication. These scheduled periods may be referred to as occasions. The UE may monitor one or more occasions (also referred to as monitoring occasions) during which the UE may monitor a channel (e.g., a physical downlink control channel (PDCCH), physical downlink shared channel (PDSCH)) for a transmission (e.g., a PDCCH message, a PDSCH message) from the NE. The NE may indicate a periodicity of the occasions, a starting time of the occasions, an ending time of the occasions, and/or a duration of the occasions, among other parameters for the occasions.

A UE may be equipped with multiple radios, such as a primary radio and a secondary radio to support various operations (e.g., receiving, transmitting, monitoring). The primary radio of the UE may be referred to as a main radio and the secondary radio may be referred to as a low power radio. The UE may be capable of, configured to, or operable to support multiple power modes. For example, the UE may operate in an active mode with relatively high power consumption or in an idle or inactive mode with a relatively low power consumption compared to the active mode. In the low power mode (e.g., idle and/or inactive mode), the UE may operate using reduced transmission and/or reception capabilities (e.g., due to reduced transmit power, energy efficient radio transceivers, low power processors, etc.), and may perform energy harvesting techniques to supplement battery power, utilize sleep modes for different circuitry (e.g., hardware) of the UE, etc. Examples of UEs that are operable in low power modes include, but are not limited to, internet of things (IoT) devices, wearable devices, remote sensor devices, and mobile devices.

In some examples, the low power radio of the UE may be referred to as a low power wake up radio (LP-WUR). The UE may power ON the primary radio (e.g., main radio) in response to different events associated with the low power radio, for example, reception of a low-power wake-up signal (LP-WUS) at the UE.

With the design of LP-WUS, subgrouping information may now be additionally carried in the LP-WUS signal. Currently, there is no design and/or methodology for LP-WUS to carry subgrouping. Since PEI monitoring is up to UE implementation when LP-WUS and PEI are both configured, there needs to be a uniform mechanism to enable two-level subgroupings when both LP-WUS and PEI signals are monitored by the UE without affecting false alarm rate and/or power saving gain.

Hence, LP-WUS subgrouping can be designed such that it supports both LP-WUS subgrouping to be used independently when PEI is not configured and/or not monitored, as well for when LP-WUS is used in tandem with PEI signal, e.g., the UE monitors both LP-WUS as well as PEI before paging.

This disclosure presents different techniques by which the LP-WUS subgrouping may be configured and designed such that it works for independent signaling as well as in tandem with PEI without affecting the false alarm rate and/or power saving gain. For instance, implementations support LP-WUS subgrouping. In examples, LP-WUS subgrouping in a cell can be configured with a new Configuration Information Element within the serving cell common signaling (e.g., System Information Block 1 (SIB1)), wherein the information element (IE) consists of parameters that enable the design of the LP-WUS subgrouping. Examples of such parameters include: poNumPerLPWUS-r19: The number of Paging Occasions (PO(s)) associated with one LP-WUS monitoring occasion; payloadSizeLPWUS-r19: The payload size of the LP-WUS signal carrying subgrouping information and/or wake-up indication. In one example, this payload size may be fixed. In another example, this payload size may vary ranging up to and not greater than a new parameter maxLPWUSSize-r19, wherein maxLPWUSSize-r19 in one implementation, could be an integer X; lpwus-FrameOffset-r19: Offset, in number of frames from the start of a reference frame for LP-WUS occasions (LOs) to the start of the first Paging Frame (PF) associated with all the PF(s) of the LO; and lpwusSubgroupinConfig-r19: New Configuration element for identifying if to use core network (CN)-based or UE-identifier (ID) based Subgrouping.

Implementations also support LP-WUS subgrouping based on PEI subgrouping. For instance, if both types of subgrouping levels (PEI Subgrouping and LP-WUS Subgrouping) are supported and configured in the cell and by the UE, the type of subgrouping for LP-WUS can be chosen on the basis of which PEI subgrouping is used. This may be regardless of whether the UE monitors for both LP-WUS and PEI, only LP-WUS or only PEI. In this case, as a default, at least PEI UE-ID based subgrouping must be supported in the cell and by the UE, to enable at least the LP-WUS UE-ID based subgrouping.

Implementations also support techniques for LO calculation. For instance, in order to receive the LP-WUS signal, the UE may be configured with one or more LOs. These LO(s) may be calculated as an offset behind the PEI-O if PEI is configured, else LO needs to be an offset from PO. In another implementation, the LO may be calculated as an offset behind PO, but this offset value varies based on whether PEI has been configured or not.

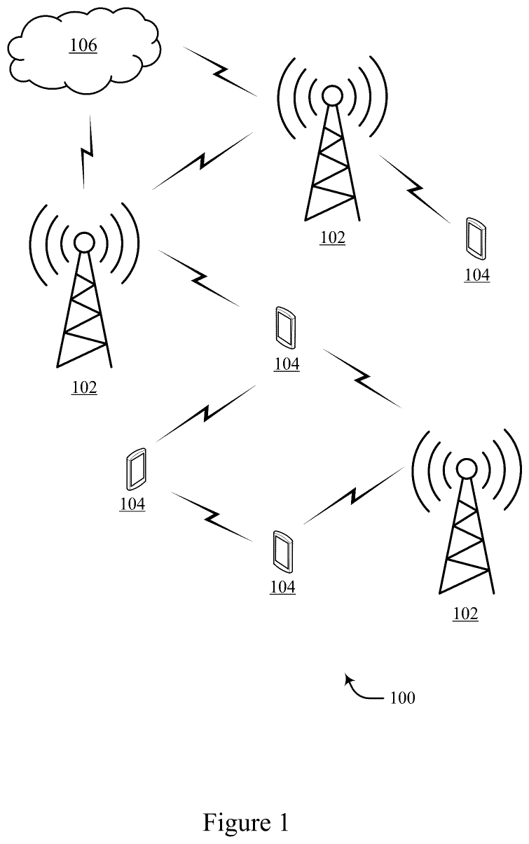

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologics). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some wireless communications systems, a cell may be configured to transmit an Early Paging Indication (PEI) by means of a DCI 2_7 signal or via a reference signal (e.g., Secondary Synchronization Signal) provided the UE also supports this feature. The PEI indication may carry some subgrouping information in order to reduce the false alarm rate and conserve power of the UEs that are not paged. Subgrouping works by dividing all the UEs monitoring a PO into N number of subgroups wherein N=1, 2, 4 or 8. The DCI 2_7 signal presently carries PEI information and/or Tracking Reference Signal (TRS) availability indication with the maximum payload size being 43 bits. Here, the payload consists of 0, 1, 2, 3, 4, 5, or 6 bits of TRS availability indication and remaining bits for PEI, where each bit in the field indicates one UE subgroup of a paging occasion. As per 3GPP Technical Specification (TS) 38.213, as given below:

A UE can be provided the following for detection of a DCI format 2_7 in RRC_IDLE state or in RRC_INACTIVE state [TS 38.331]:
a search space set, by pei-SearchSpace, to monitor PDCCH for detection of DCI format 2_7 according to a Type2A-PDCCH Common Search Space (CSS) set as described in clause 10.1
a number of frames, by pei-FrameOffset, from the start of a frame to the start of a first paging frame of paging frames associated with a number of PDCCH monitoring occasions for DCI format 2_7 [TS 38.304]
a number of symbols, by firstPDCCH-MonitoringOccasionOfPEI-O, from the start of the frame to the start of the first PDCCH monitoring occasion for DCI format 2_7
a size, by payloadSizeDCI-2-7
a number of subgroups per paging occasion,

$${N}_{SG}^{PO} ,$$

by subgroupsNumPerPO
a number of paging occasions associated with the number of PDCCH monitoring occasions for DCI format 2_7,

$${N}_{NP}^{PEI} ,$$

by po-NumPerPEI

A paging indication field of DCI format 2_7 includes

$${N}_{PO}^{PEI}$$

segments of K bits, where

$$K = {N}_{SG}^{PO} .$$

For a subgroup index i_{SG}, 0≤i_{SG}<K, a UE determines a value for the (i_{PO}·K+i_{SG}) bit in the paging indication field, where

$${i}_{PO} = ( ( UE\_IDmodN ) \cdot {N}_{S} + i\_s ) mod {N}_{PO}^{PEI}$$

is a paging occasion index, and UE_ID, N, N_{S}, i_{SG}, and i_s are defined in [TS 38.304]. When the value is ‘1’, the UE monitors a paging occasion determined according to [TS 38.304]; otherwise, the UE is not required to monitor the paging occasion. If

$${N}_{PO}^{PEI} < {N}_{S} ,$$

the number of symbols from the start of the frame to the start of the first PDCCH monitoring occasion for DCI format 2_7 that is associated with paging occasion index i_{PO} is the value from the

$$( ⌊ i\_s / {N}_{PO}^{PEI} ⌋ + 1 ) - th$$

value from the

$${N}_{S} / {N}_{PO}^{PEI}$$

values provided by firstPDCCH-MonitoringOccasionOfPEI-O.

The UE monitors one PEI occasion per Discontinuous Reception (DRX) cycle. A PEI occasion (PEI-O) is a set of PDCCH monitoring occasions (MOs) and can consist of multiple time slots (e.g. subframes or OFDM symbols) where PEI can be sent [TS 38.213]. In multi-beam operations, the UE assumes that the same PEI is repeated in all transmitted beams and thus the selection of the beam(s) for the reception of the PEI is up to UE implementation [TS 38.304].

The time location of PEI-O for UE's PO is determined by a reference point and an offset:
The reference point is the start of a reference frame determined by a frame-level offset from the start of the first PF of the PF(s) associated with the PEI-O, provided by pei-Frame Offset in SIB1;
The offset is a symbol-level offset from the reference point to the start of the first PDCCH MO of this PEI-O, provided by firstPDCCH-MonitoringOccasionOfPEI-O in SIB1.

A PEI occasion is a set of ‘S*X’ consecutive PDCCH MOs, where ‘S’ is the number of actual transmitted Synchronization Signal Blocks (SSBs) determined according to ssb-PositionsInBurst in SIB1, and X is the nrofPDCCH-MonitoringOccasionPerSSB-InPO if configured or is equal to 1 otherwise. The [x*S+K]^{th} PDCCH MO for PEI in the PEI-O corresponds to the K^{th} transmitted SSB, where x=0,1, . . . , X−1, K=1, 2, . . . , S. The PDCCH MOs for PEI which do not overlap with Uplink (UL) symbols (determined according to tdd-UL-DL-ConfigurationCommon) are sequentially numbered from zero starting from the first PDCCH MO for PEI in the PEI-O. When the UE detects a PEI within its PEI-O, the UE is not required to monitor the subsequent MO(s) associated with the same PEI-O [TS 38.304].

If the UE detects PEI and the PEI indicates the subgroup the UE belongs to monitor its associated PO, the UE monitors the associated PO. If the UE does not detect PEI on the monitored PEI occasion or the PEI does not indicate the subgroup the UE belongs to monitor its associated PO, the UE is not required to monitor the associated PO. If the UE is unable to monitor the PEI occasion (i.e. all valid PDCCH MO for PEI) corresponding to its PO, e.g. during cell re-selection, the UE monitors the associated PO [TS 38.304].

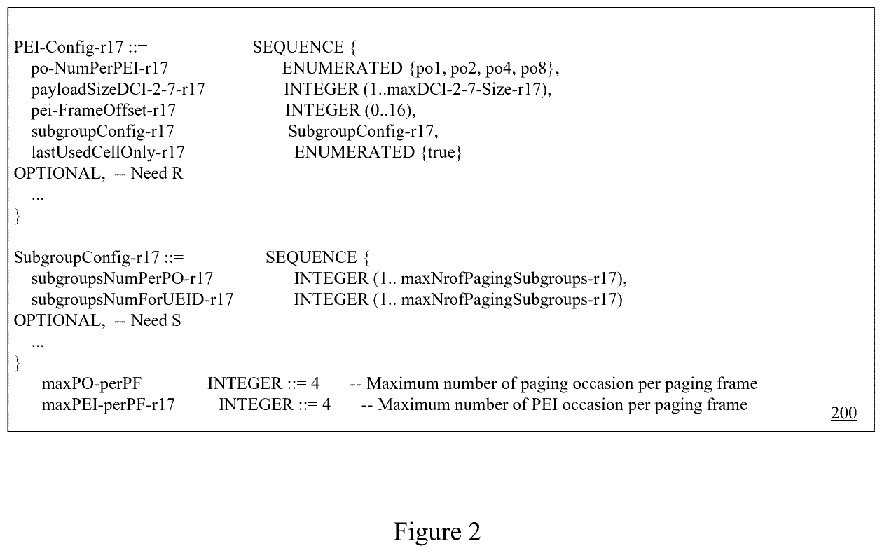

FIG. 2 illustrates an example DownlinkCommonConfigSIB 200. With the design of LP-WUS, subgrouping information may now be additionally carried in the LP-WUS signal. As a prior-art, there is no design and/or methodology for LP-WUS to carry subgrouping. In one implementation, the LP-WUS signal may just carry a 1-bit wake-up indication for the UE. For example, bit value ‘1’ indicates wake-up while bit value ‘0’ indicates no wake-up. In another implementation, when PEI is configured in the cell and for the UE, the LP-WUS subgroups may be restricted to 1. And if PEI is not configured, the LP-WUS subgrouping may reuse PEI methods, i.e., the LP-WUS subgrouping replaces PEI.

Accordingly, aspects of this disclosure provide ways for multi-level subgrouping by using PEI subgrouping methods for LP-WUS subgrouping and without impacting the false alarm rate and/or power saving gain.

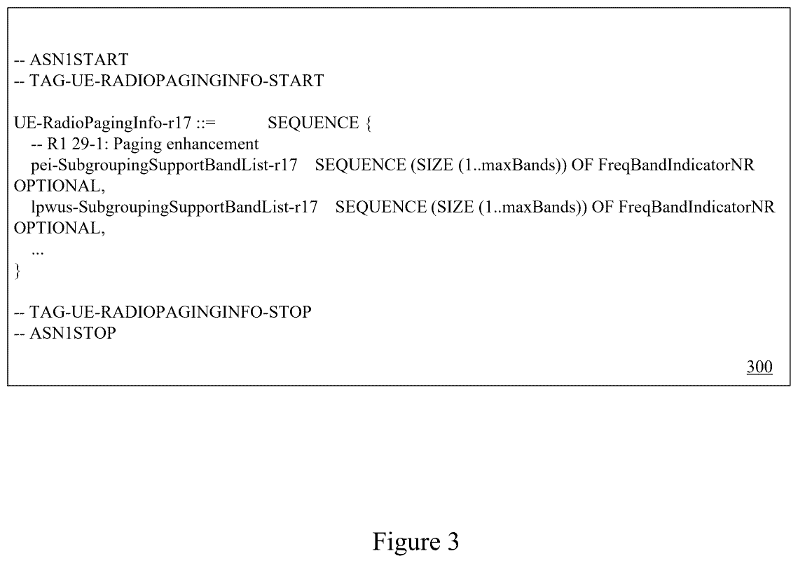

FIG. 3 illustrates a UERadioPagingInfo IE 300 in accordance with aspects of the present disclosure.

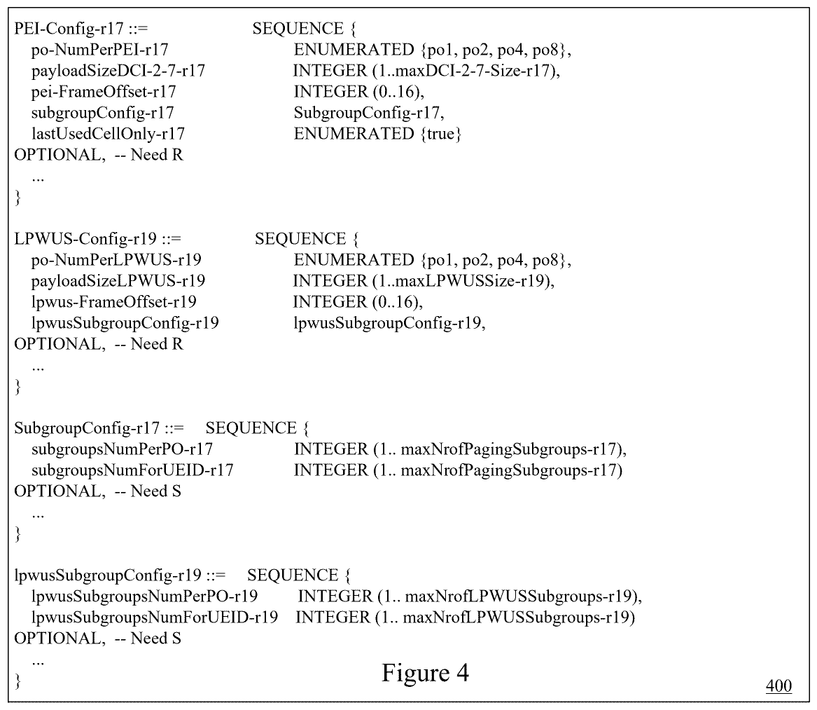

FIG. 4 illustrates an example DownlinkConfigCommonSIB IE 400 in accordance with aspects of the present disclosure. In implementations LP-WUS Subgrouping in a cell can be configured with a new Configuration Information Element within the serving cell common signaling (e.g., SIB1), where the IE 400 includes parameters that enable the design of the LP-WUS subgrouping. In at least one implementation, parameters of the IE 400 include: poNumPerLPWUS-r19: The number of PO(s) associated with one LP-WUS monitoring occasion; payloadSizeLPWUS-r19: The payload size of the LP-WUS signal carrying subgrouping information and/or wake-up indication. In one example, this payload size may be fixed. In another example, this payload size may vary ranging up to and not greater than a new parameter maxLPWUSSize-r19, wherein maxLPWUSSize-r19 in one implementation, could be an integer X; Ipwus-FrameOffset-r19: Offset, in number of frames from the start of a reference frame for LO to the start of the first PF associated with all the PF(s) of the LO; IpwusSubgroupinConfig-r19: New Configuration element for identifying if to use CN-based or UE-ID based Subgrouping.

The IpwusSubgroupinConfig-r19 element may further include parameters to decide between CN-based and UE-ID based LP-WUS subgrouping. In one implementation, these parameters may include: lpwusSubgroupsNumPerPO-r19: Total number of LP-WUS Subgroups per PO for UE to read LP-WUS subgroup indication from physical layer signaling; and lpwusSubgroupsNumForUEID-r19: The number of LP-WUS Subgroups per PO for UE to read LP-WUS subgroup indication from physical layer signaling, for UE-ID based LP-WUS Subgrouping: In at least one example, this field is absent when LP-WUS Subgrouping is configured with only CN-assigned subgrouping. And IpwusSubgroupsNumForUEID-r19 equals lpwusSubgroupsNumPerPO-r19 when only UE-ID based LP-WUS subgrouping is used. In another implementation, both these fields may be set to value ‘1’ when LP-WUS Subgrouping is not configured by the network.

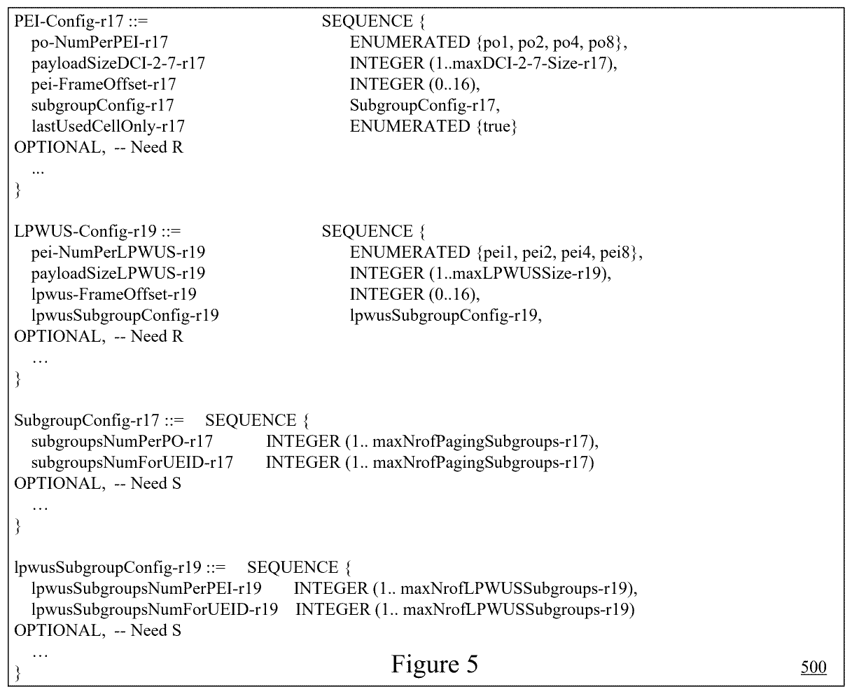

FIG. 5 illustrates an example DownlinkConfigCommon SIB information element 500 in accordance with aspects of the present disclosure. The information element 500, for instance, illustrates that these parameters may be defined on the basis of the PEI parameters (e.g., lpwusSubgroupsNumPerPEI-r19), such as when PEI Subgrouping is supported and configured in a cell.

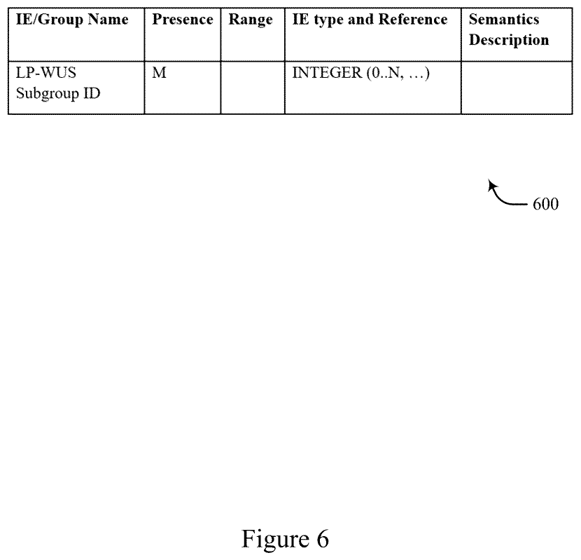

FIG. 6 illustrates an example AMF Low-Power with Paging Subgrouping (LPPS) assistance information IE 600 in accordance with aspects of the present disclosure. In implementations, a new IE can be introduced, namely-Low-Power with Paging Subgrouping (IE) to indicate the UE's support for CN-based LP-WUS Subgrouping. In one implementation, in the Registration Request message, the inclusion of the LPPS IE indicates whether the UE supports LPPS with AMF LPPS Assistance Information. In this NAS signaling, the UE may also include the paging probability information to assist the AMF with the assignment of Subgroup IDs. If the AMF supports LPPS assistance and if the UE provided Paging Subgrouping Support Indication, the AMF stores the indication in the UE context in AMF. The AMF may use local configuration, the UE's paging probability information if provided, information provided by the RAN (e.g. any of the Information On Recommended Cells And RAN nodes For Paging), and/or previous statistical information for the UE to determine the AMF LPPS Assistance Information. The AMF LPPS Assistance Information included in the IE 600 includes the LP-WUS Paging Subgroup ID as an integer value ranging from 0 to N wherein N=maximum number of subgroups supported for LP-WUS subgrouping-1 (e.g., N=7 when maximum number of LP-WUS subgroups is 8).

In implementations a network determines the total number of LP-WUS paging subgroups within a cell and broadcasts this information via SIB signaling. When the UE decodes this information, it can calculate the LP-WUS Paging Subgroup ID based on its UE-ID. When the network receives a paging message for this UE, it calculates the LP-WUS Paging Subgroup ID based on the UE-ID and indicates this in the LP-WUS signal accordingly.

According to implementations if PEI is not configured in the cell or if the UE does not support PEI but supports LP-WUS, the LP-WUS subgrouping may be configured to use the CN-based or UE-ID based methods as supported by the cell and the UE. In one implementation, this LP-WUS subgrouping may be configured by means of the LPWUS-Config-r19 IE such as described above.

If both types of subgrouping levels (e.g., PEI Subgrouping and LP-WUS Subgrouping) are supported and configured in the cell and by the UE, the type of subgrouping for LP-WUS can be chosen on the basis of which PEI subgrouping is used. In this case, as a default, at least PEI UE-ID based subgrouping must be supported in the cell as a minimum requirement for PEI to be configured. In one implementation, this LP-WUS subgrouping may be configured by means of the LPWUS-Config-r19 IE as defined in Embodiment 1.

In implementations LP-WUS subgrouping can be restricted to PEI Subgrouping Type. In such implementations, LP-WUS Subgrouping method is based on the PEI Subgrouping method, i.e., if PEI Subgrouping is CN-based then LP-WUS Subgrouping is also CN-based, and if PEI Subgrouping is UE-ID based then LP-WUS Subgrouping is also UE-ID based.

In one implementation, when PEI is CN-based (provided Early Paging Indication with Paging Subgrouping (PEIPS) with AMF PEIPS Assistance Information is supported and configured in the cell and by the UE), the AMF can additionally consider the PEI Subgroup ID of the UE before it assigns the LP-WUS Subgroup ID. For example, the LP-WUS Paging Subgroup ID may be assigned in a round-robin fashion for every UE within a PEI subgroup. In another example, the AMF may first assign the PEI Subgroup ID as per legacy methods and then assign a LP-WUS Subgroup ID for every UE within a PEI Subgroup at an offset value from the previously assigned UE in that PEI Subgroup. This offset may take an integer value Y, wherein Y may be fixed for all PEI subgroups or may vary from one PEI subgroup to another.

For instance, with reference to TS 38.304, for CN-based PEI paging with CN assigned subgrouping is used in the cell which supports CN assigned subgrouping, as described in clause 7.3.0. A UE supporting CN assigned subgrouping in RRC_IDLE or RRC_INACTIVE state can be assigned a subgroup ID (between 0 to 7) by AMF through NAS signaling. The UE belonging to the assigned subgroup ID monitors its associated PEI which indicates the paged subgroup(s) such as specified in clause 7.2 of TS 38.304.

For CN-based LP-WUS paging with CN assigned subgrouping is used in the cell which supports CN assigned subgrouping, as described in clause 7.3.0. A UE supporting CN assigned subgrouping in RRC_IDLE or RRC_INACTIVE state can be assigned a subgroup ID (between 0 to N) by AMF through NAS signaling. When PEI is also configured in the cell, the subgroup ID for a UE is assigned on the basis of the PEI subgroup ID assigned, such that every UE within a single PEI subgroup is assigned to different LP-WUS subgroups in a round-robin fashion. The UE belonging to the assigned subgroup ID monitors its associated LP-WUS which indicates the paged subgroup(s) as specified in clause 7.2.

In implementations when PEI is UE-ID based (provided the UE and the cell support such a PEI method), the number of LP-WUS subgroups can be restricted to non-factors of the subgroup number for PEI, i.e., the number of PEI subgroups configured per PO is a non-multiple of the number of LP-WUS subgroups configured. This ensures that the subgrouping design for LP-WUS is orthogonal to that of PEI subgrouping, which enables lower false alarm rate and better power saving gain in comparison to using legacy PEI methods only. Furthermore, this way of using two-level subgrouping can reduce the number of UEs that need to be awake to receive the PEI (at least as compared to when only PEI is monitored for). For example, if there are 8 subgroups per PO for PEI, then the number of subgroups per PO for LP-WUS can be 3 or 5. In one implementation, these parameters may be configurable by the network as per the IEs described above.

The discussion below provides some example text for such implementations:
UE_ID based subgrouping:
UE_ID based PEI
Paging with UE_ID based subgrouping is used in the cell which supports UE_ID based subgrouping, as described in clause 7.3.0.
If the UE is not configured with a CN assigned subgroup ID, or if the UE configured with a CN assigned subgroup ID is in a cell supporting only UE_ID based subgrouping, the subgroup ID of the UE is determined by the formula below:

$$Sub group ID = ( floor ( UE\_ID / N * Ns ) ) mod sub groups NumForUEID ) + ( sub groups NumPerPO - sub groups NumForUEID ) ,$$

where:
N: number of total paging frames in T, which is the DRX cycle of RRC_IDLE state as specified in clause 7.1
Ns: number of paging occasions for a PF
UE_ID: 5G-S-TMSI mod X, where X is 32768, if eDRX is applied; otherwise, X is 8192
subgroupsNumForUEID: number of subgroups for UE_ID based PEI subgrouping in a PO, which is broadcasted in system information
In RRC_INACTIVE state with CN configured Paging Transmission Window (PTW) the SubgroupID used outside CN PTW is the same as the SubgroupID used inside CN PTW.
The UE belonging to the SubgroupID monitors its associated PEI which indicates the paged subgroup(s) as specified in clause 7.2.

UE_ID based LP-WUS:
Paging with UE_ID based subgrouping is used in the cell which supports UE_ID based subgrouping, as described in clause 7.3.0.
If the UE is not configured with a CN assigned subgroup ID, or if the UE configured with a CN assigned subgroup ID is in a cell supporting only UE_ID based subgrouping, the subgroup ID of the UE is determined by the formula below:

$$LPSubgroupID = ( floor ( UE\_ID / ( N * Ns ) ) mod lpwusSub groups NumForUEID ) + ( lpwusSub groups NumPerPO - lpwusSub groups NumForUEID ) ,$$

where:
N: number of total paging frames in T, which is the DRX cycle of RRC_IDLE state as specified in clause 7.1
Ns: number of paging occasions for a PF
UE_ID: 5G-S-TMSI mod X, where X is 32768, if eDRX is applied; otherwise, X is 8192
lpwusSubgroupsNumForUEID: number of subgroups for UE_ID based LP-WUS subgrouping in a PO, which is a non-factor of subgroupsNumForUEID and broadcasted in system information
The UE belonging to the LPSubgroupID monitors its associated LP-WUS which indicates the paged subgroup(s) as specified in clause 7.2.

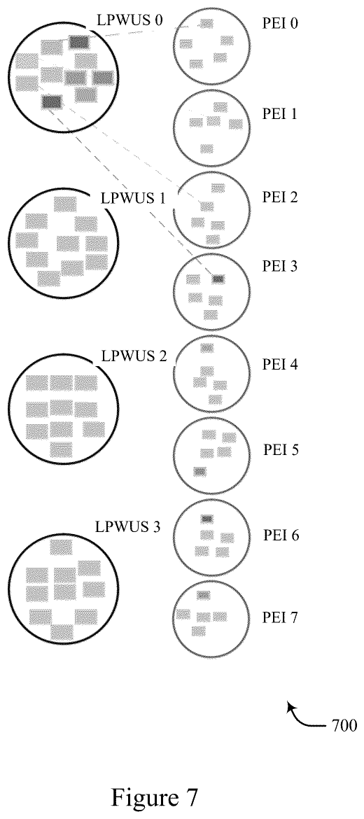

FIG. 7 illustrates an example implementation 700 for LP-WUS subgroup ID based on PEI subgroup in accordance with aspects of the present disclosure. In such implementations, an opposite subgrouping type can be used for LP-WUS, e.g., based on the PEI subgrouping type to enable randomness. Here, since the two subgroupings are calculated independently by different entities, it can be expected that some level of randomness is maintained such that power saving gain is achieved by virtue of volume. This way of subgrouping can only be possible when the cell and UE supports both CN-based as well as UE-ID based subgrouping methods. Furthermore, this case ensures that the subgroup ID calculation for LP-WUS and PEI remains completely independent from one another. For example, when PEI Subgrouping is CN-based, the LP-WUS Subgrouping will be UE-ID based. And, when PEI Subgrouping is UE-ID based, LP-WUS Subgrouping will be CN-based.

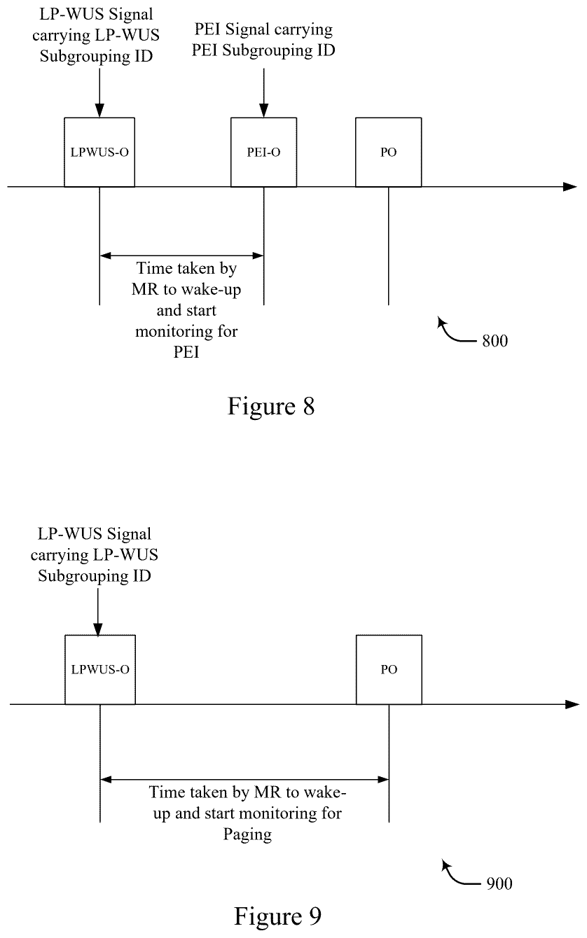

FIGS. 8 and 9 illustrate example implementations 800, 900 in accordance with aspects of the present disclosure. For instance, in order to receive the LP-WUS signal, a UE may be configured with one or LOs. These LO(s) may be calculated as an offset behind the PEI-O if PEI is configured as illustrated in the example 800, else LO may be an offset from PO. In another implementation, the LO may be calculated as an offset behind PO, and this offset value varies based on whether PEI has been configured or not such as illustrated in the example 900. As at least one example implementation, the offset may be set to 400 ms (time taken for a main radio to wake-up from ultra-deep sleep state).

In implementations, subgrouping in LP-WUS can also be done on a per PO basis, e.g., similar to PEI where all UEs monitoring the same PO is divided into LP-WUS subgroups. Furthermore, a number of PO(s) that are associated with one LO may also be configurable as defined above and/or may have a fixed value. For instance, the number of PO(s) for which one LP-WUS signal can carry subgrouping information may be configurable by the network as defined in previous embodiments or may have a fixed value. For example, each LP-WUS may only carry the subgrouping information for one PO (1:1 mapping between LP-WUS Subgrouping and PO).

In implementations subgrouping in LP-WUS can be done on a per PEI basis (e.g., where PEI is supported and configured in the cell) and where the UEs monitoring a single PEI-O can be divided into different LP-WUS subgroups. In such scenarios, the number of PEI-O(s) for which one LP-WUS signal can carry subgrouping information may be configurable by the network such as described above. For example, each LP-WUS may only carry the subgrouping information for one PEI-O, e.g., 1:1 mapping between LP-WUS Subgrouping and PEI-O.

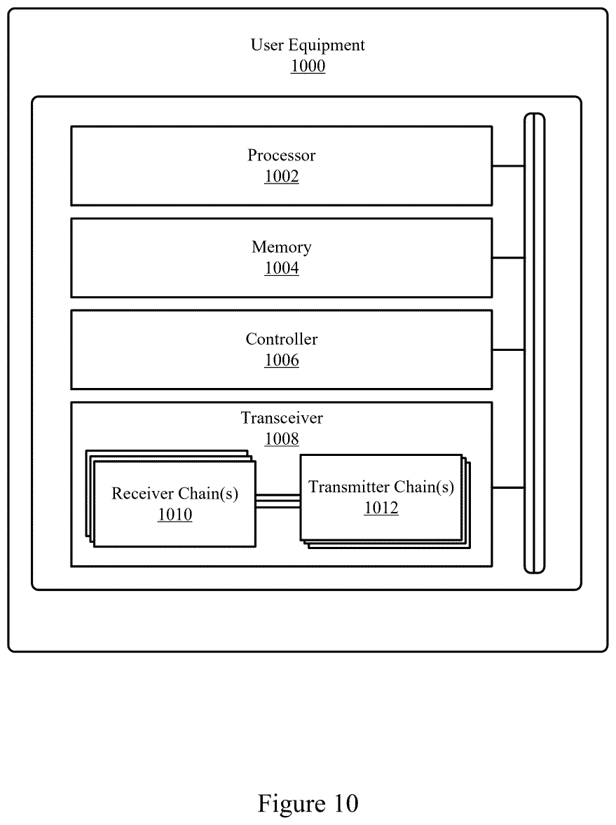

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving low power wake-up signal configuration information including low power wake-up signal subgrouping information; and generating, based at least in part on the low power wake-up signal subgrouping information, a low power wake-up signal including a subgroup identifier.

Additionally, the UE 1000 may be configured to support any one or combination of further including transmitting low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or UE identifier-based subgrouping.

Additionally, the UE 1000 may be configured to support any one or combination of the payload size includes one or more of a fixed value or a defined parameter including an integer; the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; further including determining, based at least in part on broadcast signaling, one or more of the low power wake-up signal subgrouping information or support for low power wake-up signal subgrouping information.

Additionally, or alternatively, the UE 1000 may support at least one memory (e.g., the memory 1004) and at least one processor (e.g., the processor 1002) coupled with the at least one memory and configured to cause the UE to: receive low power wake-up signal configuration information including low power wake-up signal subgrouping information; and generate, based at least in part on the low power wake-up signal subgrouping information, a low power wake-up signal including a subgroup identifier.

Additionally, the UE 1000 may be configured to support any one or combination of the at least one processor is configured to cause the UE to transmit low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping; the payload size includes one or more of a fixed value or a defined parameter including an integer.

Additionally, the UE 1000 may be configured to support any one or combination of the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the at least one processor is configured to cause the UE to determine, based at least in part on broadcast signaling, one or more of the low power wake-up signal subgrouping information or support for low power wake-up signal subgrouping information.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

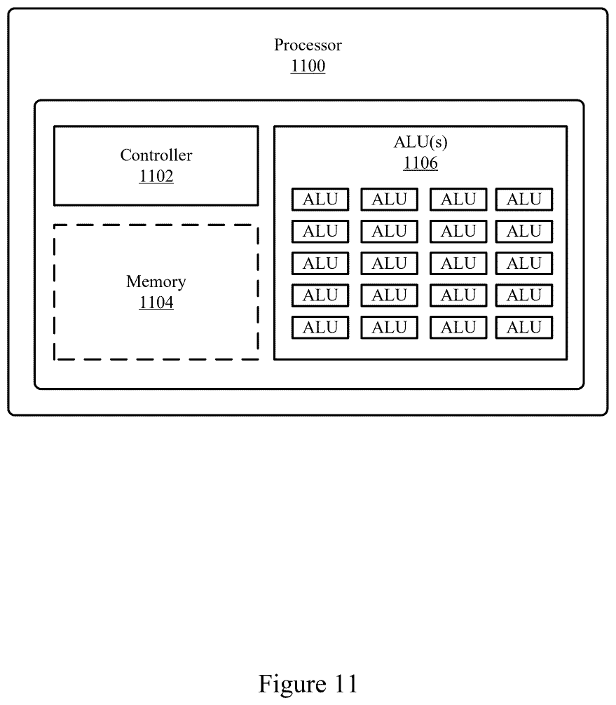

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to: receive low power wake-up signal configuration information including low power wake-up signal subgrouping information; and generate, based at least in part on the low power wake-up signal subgrouping information, a low power wake-up signal including a subgroup identifier.

Additionally, the processor 1100 may be configured to or operable to support any one or combination of where the at least one controller is configured to cause the processor to transmit low power wake-up signal subgrouping support information indicating support for low power wake-up signal subgrouping; the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication, the payload size including one or more of a fixed value or a defined parameter including an integer; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping.

Additionally, the processor 1100 may be configured to or operable to support any one or combination of where the payload size includes one or more of a fixed value or a defined parameter including an integer; the low power wake-up signal subgrouping configuration element includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the at least one controller is configured to cause the processor to determine, based at least in part on broadcast signaling, one or more of the low power wake-up signal subgrouping information or support for low power wake-up signal subgrouping information.

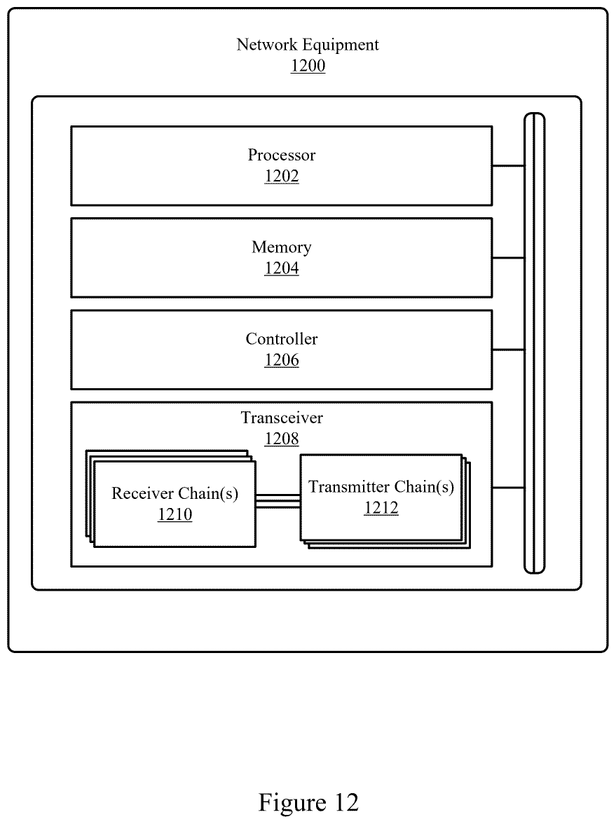

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting low power wake-up signal configuration information including low power wake-up signal subgrouping information; receiving a low power wake-up signal subgroup identifier from a core network for low power wake-up signal subgrouping; and transmitting, to a user equipment (UE), a low power wake-up signal including a subgroup identifier.

Additionally, the NE 1200 may be configured to or operable to support any one or combination of the method further comprising where the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication; an offset value in a number of frames from a start of a reference frame for a low power wake-up signal occasion to a start of a first paging frame associated with paging frames of the low power wake-up signal occasion; or a subgrouping configuration element for identifying whether to use network-based subgrouping or user equipment (UE) identifier-based subgrouping; the low power wake-up signal subgrouping configuration information includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling.

Additionally, the NE 1200 may be configured to or operable to support any one or combination of the method further comprising a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the low power wake-up signal subgrouping information includes one or more of: one or more low power wake-up signal occasions calculated as an offset behind an early paging indication occasion; or one or more low power wake-up signal occasions calculated as an offset behind a paging occasion.

Additionally, or alternatively, the NE 1200 may support at least one memory (e.g., the memory 1204) and at least one processor (e.g., the processor 1202) coupled with the at least one memory and configured to cause the NE to: transmit low power wake-up signal configuration information including low power wake-up signal subgrouping information; receive a low power wake-up signal subgroup identifier from a core network for low power wake-up signal subgrouping; and transmit, to a user equipment (UE), a low power wake-up signal including a subgroup identifier.

Additionally, the NE 1200 may be configured to support any one or combination of the at least one processor, where the low power wake-up signal configuration information includes one or more of: a number of paging occasions associated with a single low power wake-up signal monitoring occasion; a number of early paging indication occasions associated with a single low power wake-up signal monitoring occasion; a payload size of a low power wake-up signal carrying one or more of the low power wake-up signal subgrouping information or a wake-up indication; an offset value in a number of frames from a start of a reference frame for a low power wake-up signal occasion to a start of a first paging frame associated with paging frames of the low power wake-up signal occasion; or a subgrouping configuration element for identifying whether to use the network-based subgrouping or the UE identifier-based subgrouping.

Additionally, the NE 1200 may be configured to support any one or combination of the at least one processor, where the low power wake-up signal subgrouping configuration information includes one or more of: a first indication including a number of low power wake-up signal subgroups per paging occasion for the UE to read a low power wake-up signal subgroup indication from physical layer signaling; a second indication including a number of low power wake-up signal subgroups per early paging indication occasion for the UE to read a low power wake-up signal subgroup indication from physical layer signaling; a third indication including a number of low power wake-up signal subgroups per paging occasion for the UE to read a low power wake-up signal subgroup indication from physical layer signaling for the UE identifier-based subgrouping; or a fourth indication including a number of low power wake-up signal subgroups per early paging indication occasion for the UE to read a low power wake-up signal subgroup indication from physical layer signaling for the UE identifier-based subgrouping; the third indication and the fourth indication are absent when the low power wake-up signal subgrouping information comprises the network-based subgrouping; one or more of the first indication or the second indication are equal to one or more of the third indication or the fourth indication when the low power wake-up signal subgrouping information comprises the UE identifier-based subgrouping; one or more of the first indication, the second indication, the third indication, or the fourth indication are set to a value of 1 when low power wake-up signal subgrouping information is not network configured; the low power wake-up signal subgrouping information includes one or more of: one or more low power wake-up signal occasions calculated as an offset behind an early paging indication occasion; or one or more low power wake-up signal occasions calculated as an offset behind a paging occasion.

The NE 1200 may be configured to or operable to support a means for generating low power wake-up signal configuration information including one or more of generating, in a round-robin manner, low power wake-up signal subgroup identifiers for user equipment (UEs) within an early paging indication subgroup for network-based subgrouping; or configuring a number of low power wake-up signal subgroups as a non-factor of a number of early paging indication subgroups for UE-identifier based subgrouping; and transmitting, to the UEs within the early paging indication subgroup, at least some of the low power wake-up signal configuration information.

Additionally, or alternatively, the NE 1200 may support at least one memory (e.g., the memory 1204) and at least one processor (e.g., the processor 1202) coupled with the at least one memory and configured to cause the NE to generate low power wake-up signal configuration information including one or more of generating, in a round-robin manner, low power wake-up signal subgroup identifiers for user equipment (UEs) within an early paging indication subgroup for network-based subgrouping; or configuring a number of low power wake-up signal subgroups as a non-factor of a number of early paging indication subgroups for UE-identifier based subgrouping; and transmit, to the UEs within the early paging indication subgroup, at least some of the low power wake-up signal configuration information.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

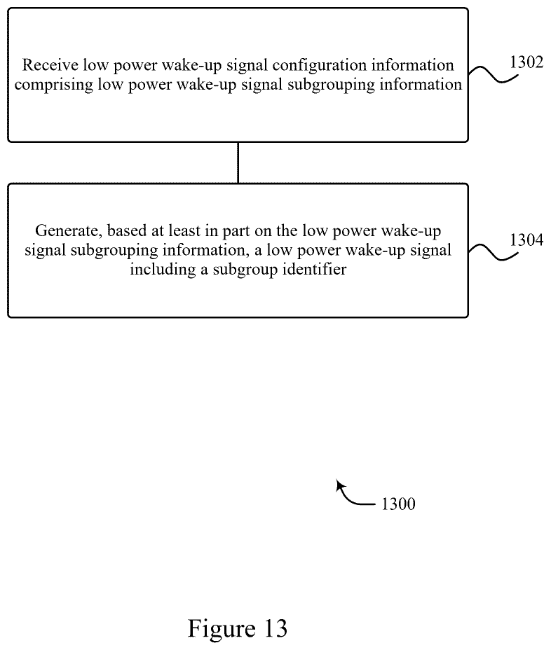

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving low power wake-up signal configuration information comprising low power wake-up signal subgrouping information. The operations of 1302 may be performed in accordance with examples as described herein. In some implementations, aspects of the operations of 1302 may be performed by a UE as described with reference to FIG. 10.

At 1304, the method may include generating, based at least in part on the low power wake-up signal subgrouping information, a low power wake-up signal including a subgroup identifier. The operations of 1304 may be performed in accordance with examples as described herein. In some implementations, aspects of the operations of 1304 may be performed by a UE as described with reference to FIG. 10.

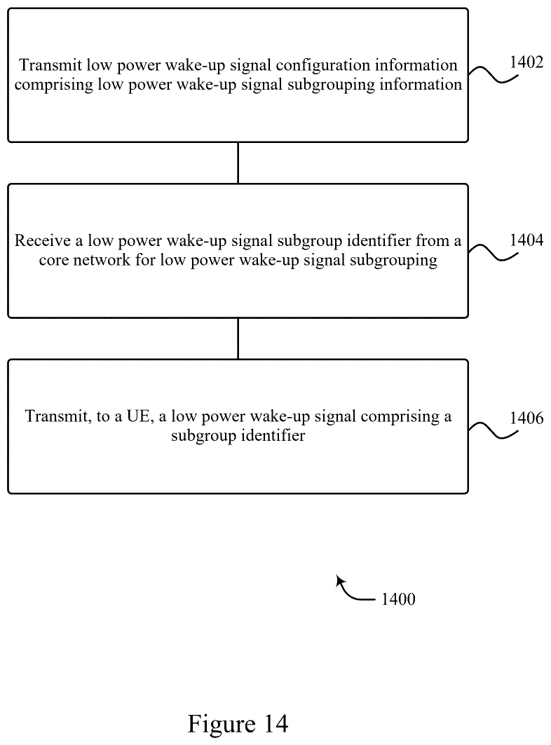

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting low power wake-up signal configuration information comprising low power wake-up signal subgrouping information. The operations of 1402 may be performed in accordance with examples as described herein. In some implementations, aspects of the operations of 1402 may be performed by a NE as described with reference to FIG. 12.

At 1404, the method may include receiving a low power wake-up signal subgroup identifier from a core network for low power wake-up signal subgrouping. The operations of 1404 may be performed in accordance with examples as described herein. In some implementations, aspects of the operations of 1404 may be performed by a NE as described with reference to FIG. 12.

At 1406, the method may include transmitting, to a UE, a low power wake-up signal comprising a subgroup identifier. The operations of 1406 may be performed in accordance with examples as described herein. In some implementations, aspects of the operations of 1406 may be performed a NE as described with reference to FIG. 12.

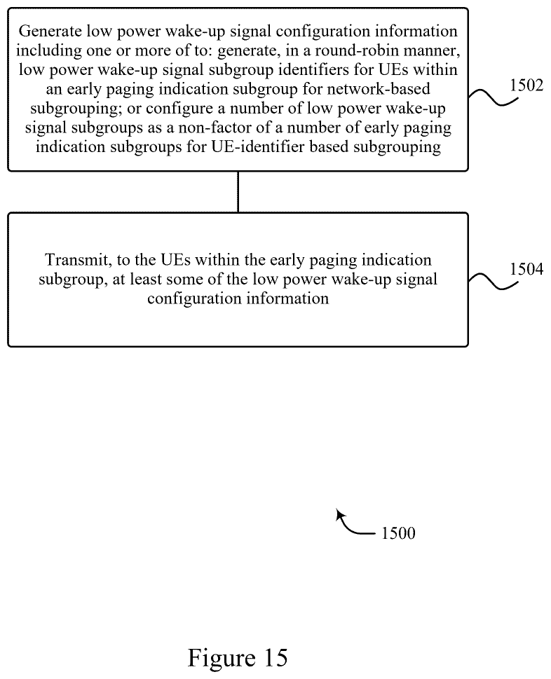

FIG. 15 illustrates a flowchart of a method 1500 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include generating low power wake-up signal configuration information including one or more of: generating, in a round-robin manner, low power wake-up signal subgroup identifiers for UEs within an early paging indication subgroup for network-based subgrouping; or configuring a number of low power wake-up signal subgroups as a non-factor of a number of early paging indication subgroups for UE-identifier based subgrouping. The operations of 1502 may be performed in accordance with examples as described herein. In some implementations, aspects of the operations of 1502 may be performed by a NE as described with reference to FIG. 12.

At 1504, the method may include transmitting, to the UEs within the early paging indication subgroup, at least some of the low power wake-up signal configuration information. The operations of 1504 may be performed in accordance with examples as described herein. In some implementations, aspects of the operations of 1504 may be performed by a NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive low power wake-up signal configuration information comprising low power wake-up signal subgrouping information; and
generate, based at least in part on the low power wake-up signal subgrouping information, a low power wake-up signal including a subgroup identifier.

2. The UE of claim 1, wherein the at least one processor is configured to cause the UE to transmit low power wake-up signal subgrouping support information indicating support for low power wake-up signal subgrouping.

3. The UE of claim 1, wherein the low power wake-up signal configuration information comprises one or more of:
a number of paging occasions associated with a single low power wake-up signal monitoring occasion;
a number of early paging indication occasions associated with a single low power wake-up signal monitoring occasion;
a payload size of a low power wake-up signal carrying one or more of the low power wake-up signal subgrouping information or a wake-up indication, the payload size comprising one or more of a fixed value or a defined parameter comprising an integer;
an offset value in a number of frames from a start of a reference frame for a low power wake-up signal occasion to a start of a first paging frame associated with paging frames of the low power wake-up signal occasion; or
a subgrouping configuration element for identifying whether to use network-based subgrouping or UE identifier-based subgrouping.

4. The UE of claim 3, wherein the payload size comprises one or more of a fixed value or a defined parameter comprising an integer.

5. The UE of claim 3, wherein the low power wake-up signal subgrouping configuration element comprises one or more of:
a first indication comprising a number of low power wake-up signal subgroups per paging occasion for the UE to read a low power wake-up signal subgroup indication from physical layer signaling;
a second indication comprising a number of low power wake-up signal subgroups per early paging indication occasion for the UE to read a low power wake-up signal subgroup indication from physical layer signaling;
a third indication comprising a number of low power wake-up signal subgroups per paging occasion for the UE to read a low power wake-up signal subgroup indication from physical layer signaling for the UE identifier-based subgrouping; or
a fourth indication comprising a number of low power wake-up signal subgroups per early paging indication occasion for the UE to read a low power wake-up signal subgroup indication from physical layer signaling for the UE identifier-based subgrouping.

6. The UE of claim 5, wherein the third indication and the fourth indication are absent when the low power wake-up signal subgrouping information comprises the network-based subgrouping.

7. The UE of claim 5, wherein one or more of the first indication or the second indication are equal to one or more of the third indication or the fourth indication when the low power wake-up signal subgrouping information comprises the UE identifier-based subgrouping.

8. The UE of claim 5, wherein one or more of the first indication, the second indication, the third indication, or the fourth indication are set to a value of 1 when low power wake-up signal subgrouping information is not network configured.

9. The UE of claim 1, wherein the at least one processor is configured to cause the UE to determine, based at least in part on broadcast signaling, one or more of the low power wake-up signal subgrouping information or support for low power wake-up signal subgrouping information.

10. A network equipment for wireless communication, comprising:
at least one memory; and
at least one processor coupled with the at least one memory and configured to cause the network equipment to:
transmit low power wake-up signal configuration information comprising low power wake-up signal subgrouping information;
receive a low power wake-up signal subgroup identifier from a core network for low power wake-up signal subgrouping; and
transmit, to a user equipment (UE), a low power wake-up signal comprising a subgroup identifier.

11. The network equipment of claim 10, wherein the low power wake-up signal configuration information comprises one or more of:
a number of paging occasions associated with a single low power wake-up signal monitoring occasion;
a number of early paging indication occasions associated with a single low power wake-up signal monitoring occasion;
a payload size of a low power wake-up signal carrying one or more of the low power wake-up signal subgrouping information or a wake-up indication;
an offset value in a number of frames from a start of a reference frame for a low power wake-up signal occasion to a start of a first paging frame associated with paging frames of the low power wake-up signal occasion; or
a subgrouping configuration element for identifying whether to use network-based subgrouping or UE identifier-based subgrouping.

12. The network equipment of claim 11, wherein the low power wake-up signal subgrouping configuration information comprises one or more of:
a first indication comprising a number of low power wake-up signal subgroups per paging occasion for the UE to read a low power wake-up signal subgroup indication from physical layer signaling;
a second indication comprising a number of low power wake-up signal subgroups per early paging indication occasion for the UE to read a low power wake-up signal subgroup indication from physical layer signaling;
a third indication comprising a number of low power wake-up signal subgroups per paging occasion for the UE to read a low power wake-up signal subgroup indication from physical layer signaling for the UE identifier-based subgrouping; or
a fourth indication comprising a number of low power wake-up signal subgroups per early paging indication occasion for the UE to read a low power wake-up signal subgroup indication from physical layer signaling for the UE identifier-based subgrouping.

13. The network equipment of claim 12, wherein the third indication and the fourth indication are absent when the low power wake-up signal subgrouping information comprises the network-based subgrouping.

14. The network equipment of claim 12, wherein one or more of the first indication or the second indication are equal to one or more of the third indication or the fourth indication when the low power wake-up signal subgrouping information comprises the UE identifier-based subgrouping.

15. The network equipment of claim 12, wherein one or more of the first indication, the second indication, the third indication, or the fourth indication are set to a value of 1 when low power wake-up signal subgrouping information is not network configured.

16. The network equipment of claim 10, wherein the low power wake-up signal subgrouping information comprises one or more of:
one or more low power wake-up signal occasions calculated as an offset behind an early paging indication occasion; or
one or more low power wake-up signal occasions calculated as an offset behind a paging occasion.

17. A processor for wireless communication, comprising:
at least one controller coupled with at least one memory and configured to cause the processor to:
receive low power wake-up signal configuration information comprising low power wake-up signal subgrouping information; and
generate, based at least in part on the low power wake-up signal subgrouping information, a low power wake-up signal subgroup identifier.

18. The processor of claim 17, wherein the at least one controller is configured to cause the processor to transmit low power wake-up signal subgrouping support information indicating support for low power wake-up signal subgrouping.

19. The processor of claim 17, wherein the at least one controller is configured to cause the processor to determine, based at least in part on broadcast signaling, one or more of the low power wake-up signal subgrouping information or subgrouping identifier.

20. A network equipment for wireless communication, comprising:
at least one memory; and
at least one processor coupled with the at least one memory and configured to cause the network equipment to:
generate low power wake-up signal configuration information including one or more of to:
generate, in a round-robin manner, low power wake-up signal subgroup identifiers for user equipment (UEs) within an early paging indication subgroup for network-based subgrouping; or
configure a number of low power wake-up signal subgroups as a non-factor of a number of early paging indication subgroups for UE-identifier based subgrouping; and
transmit, to the UEs within the early paging indication subgroup, at least some of the low power wake-up signal configuration information.
